(19) United States
(12) Patent Application Publication
(10) Pub. No.: US 2014/0068452 A1
(43) Pub. Date: Mar. 6, 2014

(54) Communication Sessions

(71) Applicant: Metaswitch Networks Ltd, Enfield (GB)

(72) Inventors: Tim JOSEPH, Enfield (GB); Mark THOMAS, Enfield (GB)

(21) Appl. No.: 14/013,577

(22) Filed: Aug. 29, 2013

(30) Foreign Application Priority Data
Aug. 31, 2012 (GB) 1215545.3

(51) Int. Cl. H04L 12/24

(52) U.S. Cl. CPC H04L 41/22
USPC 715/738

(57) ABSTRACT

Measures for moving an established communication session in a telecommunications network, the communication session being established between a first device in a plurality of user devices associated with a user and a remote device associated with a remote party, to a second device in the plurality. On the basis of prioritisation data indicating a prioritisation of at least one user device in the plurality over at least one other user device in the plurality for moving the established communication session to, a user interface on a given device in the plurality is configured to display at least one communication session move option to the user. User input is received via the user interface indicating selection of the displayed at least one communication session move option by the user. Move of the established communication from the first device in the plurality to the second device in the plurality is initiated.

### CROSS REFERENCE TO RELATED APPLICATION

This application claims benefit under 35 U.S.C. §119(a) and 37 CFR 1.55 to UK patent application no. GB 1215545.3, filed on 31 Aug. 2012, the entire content of which is hereby incorporated by reference.

### TECHNICAL FIELD

The present disclosure relates to communication sessions. In particular, but not exclusively, the present disclosure relates to moving an established communication session in a telecommunications network, the communication session being established between a first device in a plurality of user devices associated with a user and a remote device associated with a remote party, to a second device in the plurality.

### BACKGROUND

Telephony users have long had to deal with a proliferation of user devices (sometimes referred to as ‘user equipment’ or ‘endpoints’) through which third parties may contact them. For example, a user might have a fixed-line (or ‘wireline’) user device for use at home, a further fixed-line telephony user device for use in the office, and a mobile user device for use whilst on the move. Each type of user device has associated advantages; whilst a mobile user device provides the user with mobility, a fixed-line user device typically provides more reliable and higher quality communications and no battery recharge concerns.

Users may also have a number of different access technologies available through which their user devices may conduct communications. For example, a user device may be equipped with a circuit-switched communication interface and one or more circuit-switched communication clients for conducting communications via suitable circuit-switched networks. Likewise, a user device may also/alternatively be equipped with a packet-switched communication interface and one or more packet-switched communication clients for communicating via suitable packet-switched networks.

A circuit-switched user device may comprise a fixed-line Plain Old Telephone Service (POTS) telephone equipped with a circuit-switched interface and communication client for conducting communications via a Public Switched Telephone Network (PSTN). A circuit-switched user device may comprise a mobile (or ‘cellular’) telephone equipped with a wireless circuit-switched interface and communication client for conducting communications via a cellular network such as a Global System for Mobile Communications (GSM) network or Code Division Multiple Access (CDMA) network.

More recently, packet-switched user devices have proliferated which may take the form of a fixed-line Internet Protocol (IP) telephone equipped with a fixed-line packet-switched interface and communication client for communicating via an IP network, such as the internet or an IP Private Branch Exchange (IP-PBX). Similarly, a user may conduct communications via a personal computer (PC) equipped with a packet-switched communication client for conducting communications over the internet via a fixed-line internet connection. A mobile packet-switched telephony device may take the form of a portable computing device, such as a laptop or tablet, equipped with a wireless packet-switched interface and communication client for communicating via an IP network, such as the internet, using a Wi-Fi™ or Bluetooth™ compliant wireless access point. A packet-switched communication client may conduct communications according to an internet telephony protocol, commonly referred to as Voice over Internet Protocol (VoIP), with associated setup and control protocols such as the Session Initiation Protocol (SIP) or H.323.

When a user is conducting a communication session on a user device, the user may wish to move (or ‘jump’ or ‘switch’) the communication session to another user device. Communication session jump is generally accepted to be a distinct service to communication session transfer. Communication session transfer is used to transfer a communication session to a different user, whereas communication session jump moves the communication session to another device owned by the same user, so the two services involve a different user experience. For example, during a communication session transfer, the remote call party is either placed on hold or hears a ring-back tone while the transfer recipient's phone rings. In contrast, a communication session jump service attempts to minimize the disruption to the communication session as perceived by the remote party, so the remote party is not placed on hold and does not hear any call progress tones or suchlike.

Some known call jump systems employ a communication session ‘push’ technique where a user initiates the communication session jump from within a communication session they are currently conducting on one of their user devices. Some such known techniques require a user firstly to enter in a number of digits on their device for activating the communication session jump, for example entering digits of a ‘star code’, and optionally entering in digits identifying the device the communication session is to be pushed to. Other known communication session jump systems employ a communication session ‘pull’ technique where a user invokes the communication session jump from a user device other than the user device currently being used to conduct the communication session, and similarly may require a user to enter in a number of digits on the other device for activating the communication session jump and entering in digits identifying the device the communication session is to be pulled from.

When a user with multiple associated user devices is initiating communication session jump functionality on one of their user devices, the user has multiple options as to which other user device the communication session should be jumped to. In such a scenario, the user may be presented with a list of multiple available user devices to which the communication session could be jumped to and it may take some time for the user to find the device they want to jump the communication session to.

It would therefore be desirable to provide improved communication session jump services.

### SUMMARY

In accordance with first embodiments, there is a method for use in moving an established communication session in a telecommunications network, the communication session being established between a first device in a plurality of user devices associated with a user and a remote device associated with a remote party, to a second device in the plurality, the method comprising, at a given device in the plurality:

on the basis of prioritisation data indicating a prioritisation of at least one user device in the plurality over at least one other user device in the plurality for moving the established communication session to, configuring a user interface on the given device to display at least one communication session move option to the user;

receiving, via the user interface, user input indicating selection of the displayed at least one communication session move option by the user; and

initiating move of the established communication from the first device in the plurality to the second device in the plurality.

In accordance with second embodiments, there is apparatus for use in moving an established communication session in a telecommunications network, the communication session being established between a first device in a plurality of user devices associated with a user and a remote device associated with a remote party, to a second device in the plurality, the apparatus comprising at least one processor, and at least one memory including computer program code, the at least one memory and the computer program code being configured to, with the at least one processor, cause the apparatus at least to, at a given device in the plurality:

on the basis of prioritisation data indicating a prioritisation of at least one user device in the plurality over at least one other user device in the plurality for moving the established communication session to, configure a user interface on the given device to display at least one communication session move option to the user;

receive, via the user interface, user input indicating selection of the displayed at least one communication session move option by the user; and

initiate move of the established communication from the first device in the plurality to the second device in the plurality.

In accordance with third embodiments, there is a computer program product comprising a non-transitory computer-readable storage medium having computer readable instructions stored thereon, the computer readable instructions being executable by a computerised device to cause the computerised device to perform a method for use in moving an established communication session in a telecommunications network, the communication session being established between a first device in a plurality of user devices associated with a user and a remote device associated with a remote party, to a second device in the plurality, the method comprising, at a given device in the plurality:

on the basis of prioritisation data indicating a prioritisation of at least one user device in the plurality over at least one other user device in the plurality for moving the established communication session to, configuring a user interface on the given device to display at least one communication session move option to the user;

receiving, via the user interface, user input indicating selection of the displayed at least one communication session move option by the user; and

initiating move of the established communication from the first device in the plurality to the second device in the plurality.

Further features of embodiments will become apparent from the following description of preferred embodiments, given by way of example only, which is made with reference to the accompanying drawings.

### BRIEF DESCRIPTION OF THE DRAWINGS

FIG. 1 shows a system diagram according to embodiments;

FIG. 2 shows a block diagram according embodiments;

FIG. 3 shows a flow diagram according to embodiments;

FIG. 4 shows a screen-shot of a user device according to embodiments;

FIG. 5 shows a flow diagram according to embodiments;

FIG. 6 shows a screen-shot of a user device according to embodiments;

FIG. 7 shows a block diagram according embodiments;

FIG. 8 shows a block diagram according embodiments;

FIG. 9 is a front view of a user device according to embodiments;

FIG. 10 is a front view of a user device according to embodiments; and

FIG. 11 is a front view of a user device according to embodiments.

### DETAILED DESCRIPTION

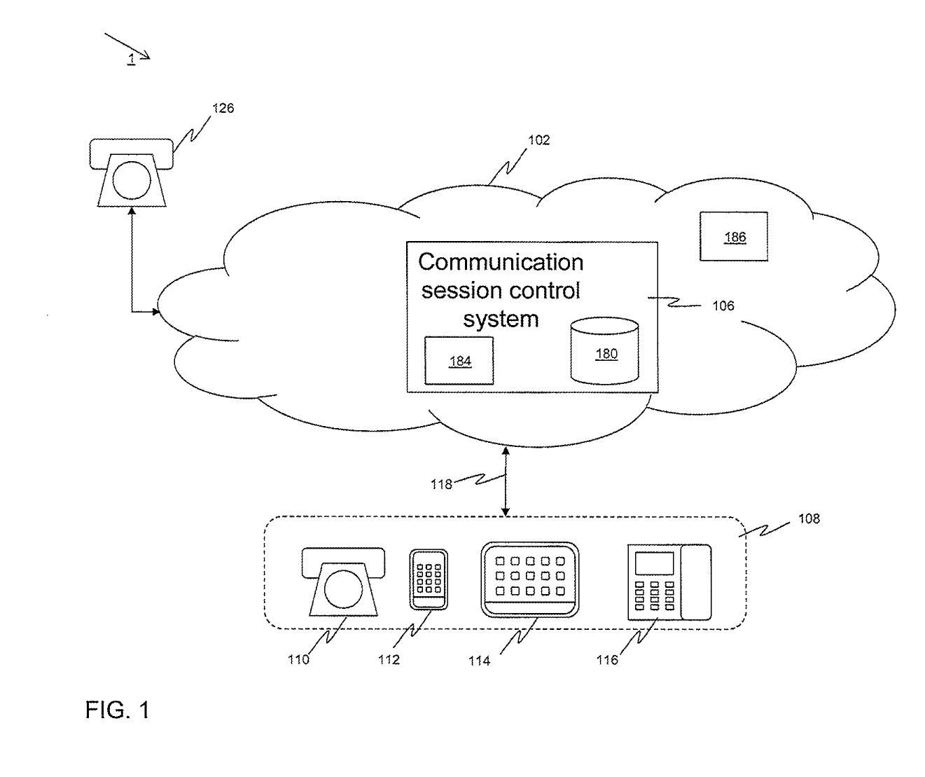

FIG. 1 shows a system diagram of a system 1 according to embodiments. System 1 includes a telecommunications network 102 which may for example include one or more PSTN parts, one or more mobile (or ‘cellular’) telephone network parts and/or one or more packet-switched network parts such as the Internet (not shown). Telecommunications network 102 may comprise one or more gateway or session border controller entities (not shown) which carry out conversion between the various protocols and data formats used to transfer media data and signalling data in different network parts making up telecommunications network 102. For example, a media gateway (not shown) may convert between the different protocols of media data passing between a circuit-switched network part and a packet-switched network part of telecommunications network 102, such as packetised VoIP data into Time-Division-Multiplexing (TDM) voice data and vice versa. A signalling gateway (not shown) may convert between the different protocols of signalling information passing between a circuit-switched network part and a packet-switched network part of telecommunications network 102, such as SIP, Signalling System 7 (SS7), Integrated Services Digital Network User Part (ISUP), American National Standards Institute (ANSI)—41, Mobile Application Part (MAP) formats, etc.

Telecommunications network 102 includes a communication session control system 106 which is responsible for providing communication session control services including hosting and control of call jump services. Communication session control system 106 may also be referred to as a media gateway controller, service platform, call agent, application server or softswitch and may also perform other functions typically associated with such entities. Although depicted in FIG. 1 as a single network entity, communication session control system 106 may comprise a plurality of network entities, with elements located within telecommunications network 102 or one or more other networks (not shown). Communication session control system 106 may comprise (or have access to) a database 180 for storing data associated with communication session control services including communication session jump services.

A user of communication session jump services has a plurality of user devices 108 through which they may conduct communication sessions with other remote user devices via communication session control system 106. The various user devices 108 through which a user can conduct communications sessions are considered to be associated with that user. The user's associated devices may include, for example, home landline phone 110, mobile (or ‘cellular’) telephone 112, tablet 114 and/or work deskphone 116. Each of the user's telephony devices is equipped with one or more interfaces and one or more communication clients for conducting communications in telecommunications network 102 via link(s) 118. Link 118 could comprise a wired link to telecommunications network 102 in the case of a fixed location device such as home landline phone 110 or work deskphone 116, and/or a wireless link (e.g. Wi-Fi, Bluetooth, 3G-LTE, WiMax, etc.) to telecommunications network 102 in the case of mobile telephone 112 or tablet 114.

In order to provide communication session jump services in telecommunications network 102, signalling information for communication sessions conducted between one of the user's devices 108 and a user device of a remote party 126 is routed through telecommunications network 102 via communication session control system 106. Communication session control system 106 is therefore located in the signalling path for communication sessions conducted to/from a user's devices 108 and will typically remain in the signalling path for the duration of such communication sessions.

Communication session control system 106 may also be located in the media path for communication sessions conducted to/from a user's devices 108.

In order to host communication session jump services in telecommunications network 102, communication session control system 106 needs to provide control functionality associated with enabling communication session jump services, including capabilities for processing signalling information and state information associated with such. Communication session control system 106 may comprise a processing system or one or more processors 184 for carrying out such functions.

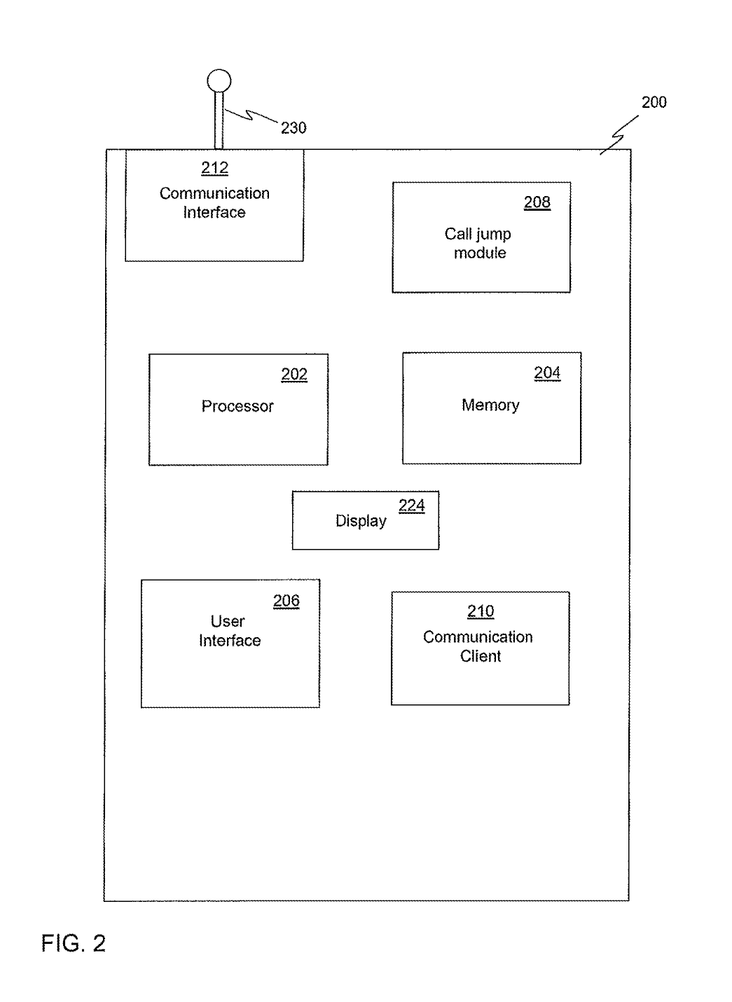

FIG. 2 shows a block diagram of a user device 200 according to embodiments. User device 200 is adapted for conducting and jumping of communication sessions such as voice and/or video calls in telecommunication network 102 according to embodiments. User device 200 may for example comprise mobile telephone 112 or tablet 114 depicted in FIG. 1.

User device 200 comprises a processor 202 for carrying out data processing tasks of embodiments and other functionality of user device 200. User device 200 comprises a memory 204 for storing data, including contact information for other user devices and prioritisation data and geographical location data according to embodiments described below. User device 200 comprises a user interface 206 for collecting user input from a user of the device, including user input associated with setting up and acceptance of communication sessions, such as telephone dialing number digits, and call jump operations.

In some embodiments, communication session jump is controlled by processor 202, in other embodiments, communication session jump is controlled by a dedicated call jump module 208, and in still other embodiments, communication session jump is controlled by a combination of processor 202 and call jump module 208.

In embodiments, user device 200 comprises a display 224. In embodiments display 224 comprises a touch-screen display, which, in conjunction with user interface 206, forms a graphical user interface. One or more touch-sensitive screen regions (or ‘buttons’) are configurable by processor 202 on the graphical user interface.

In embodiments, user device 200 comprises a communication client 210 adapted to communicate with telecommunications network 102. User device 200 includes one or more antennae 230 connected to communication interface 212 for wireless radio communication. User device 200 may contain multiple different communication clients, antennae and communication interfaces.

In some embodiments, communication client 210 comprises a cellular communication client adapted to communicate via a cellular part of telecommunications network 102 and/or a VoIP communication client adapted to communicate via a packet-switched part of telecommunications network 102. In embodiments, communication interface 212 comprises a cellular radio modem and/or a non-cellular radio modem.

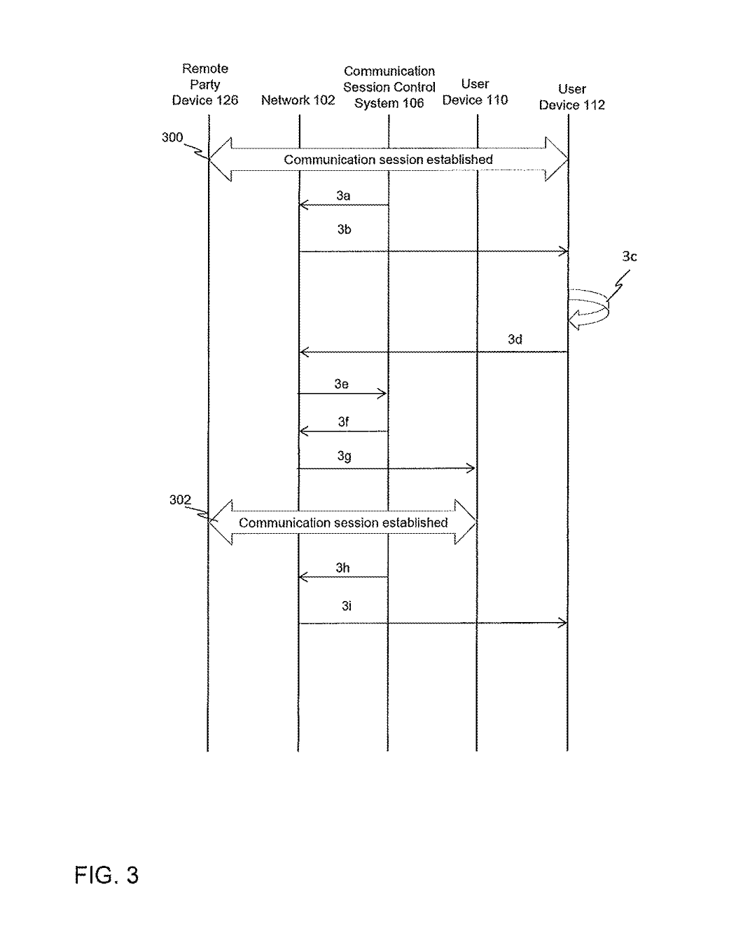

Embodiments described below in relation to FIG. 3 enable moving (or ‘jumping’ or ‘switching’) of an established communication session in telecommunications network 102 from one user device associated with a user to another user device associated with that user. A communication session 300 is established between one of a plurality of user devices associated with a user at which the user can be contacted at, in this example user device 112 and a remote device 126 associated with a remote party. Mechanisms for establishing such a communication session will be known to one skilled in the art and will not be described herein.

In embodiments, communication session control system 106 is located in the signalling path for the established communication session and maintains a user database 180 containing user entries for a plurality of users, each user entry comprising contact data and/or a set of identifiers for user devices associated with the respective user.

Upon establishment of communication session 300 between user device 112 and remote party device 126, communication session control system 106 performs a lookup in database 180 for the user of user device 112 and determines that the user also has an associated user device 110. Communication session control system 106 therefore notifies user device 112 that there is a further user device 110 associated with the user via network 102 in steps 3a and 3b.

Upon receipt of the notification of step 3b, user interface 206 on user device 112 is configured to display at least one communication session move option to the user, in this case an option to jump the communication session established between user device 112 and remote user device 126 to user device 110.

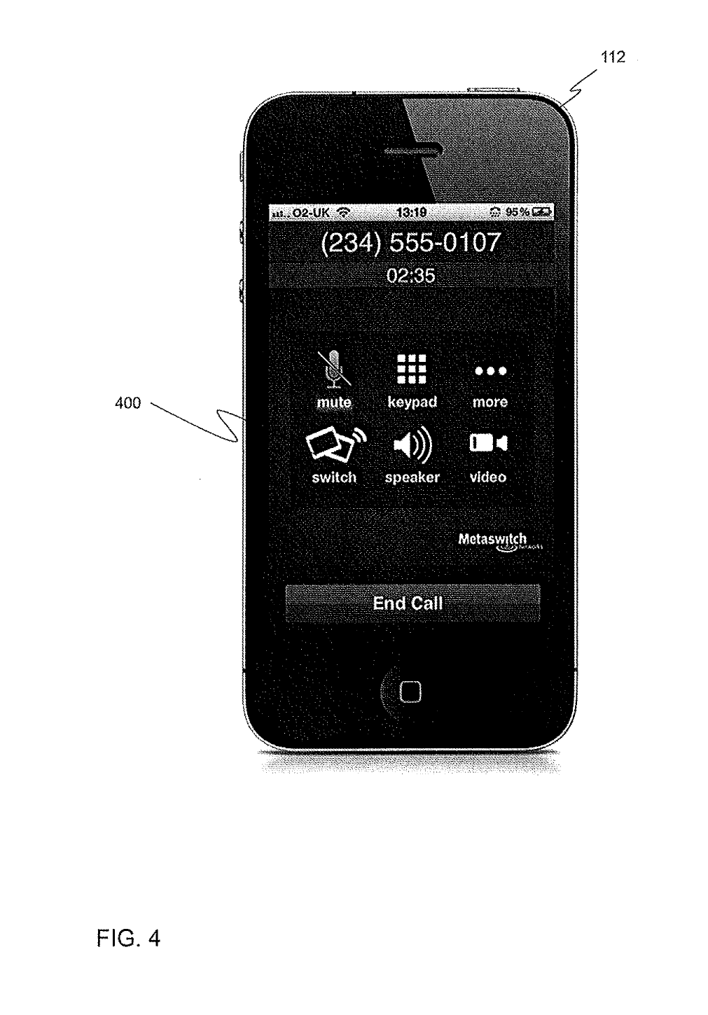

An example screen-shot of user device 112 configured to display at least one communication session move option to the user is depicted in FIG. 4 according to embodiments. Button 400 includes the text ‘switch’ indicating to the user that selecting this button will allow them to switch (or ‘move’ or ‘jump’) the established communication session to another of their user devices (in this case user device 110).

User input is received via user interface 206, as shown by step 3c, which indicates selection of the displayed at least one communication session move option by the user of user device 112.

User device 112 transmits, to communication session control system 106, a communication session move request via network 102, as shown by steps 3d and 3e in FIG. 3. The communication session jump request of step 3e is operable to instruct communication session control system 106 to initiate moving of the established communication session from user device 112 to user device 110. In response to receipt of the communication session jump request of step 3e, communication session control system 106 initiates, in steps 3f and 3g, moving of the communication session established between user device 112 to user device 110 in the plurality of user devices associated with the user of user device 112.

In embodiments, the communication session move is conducted on the basis of a preconfigured data set, specific to the user, which identifies one or more of the plurality of user devices associated with the user. In some embodiments, the preconfigured data set is maintained by communication session control system 106 and its contents retrieved from database 180 by communication session control system 106 as and when required. In other embodiments, the preconfigured data set is stored and maintained by user device 112 and/or user device 110 and its contents provided to communication session control system 106 by user device 112 and/or user device 110 as and when required.

A communication session 302 is thus established between user device 110 and remote party device 126. Communication session 300 established between user device 112 and remote party device 126 is torn down in steps 3h and 3i such that communication session 302 replaces communication session 300.

The operation of moving a communication session from user device 112 to user device 110 as depicted in FIG. 3 can be described as a ‘push’ operation from user device 112 to user device 110.

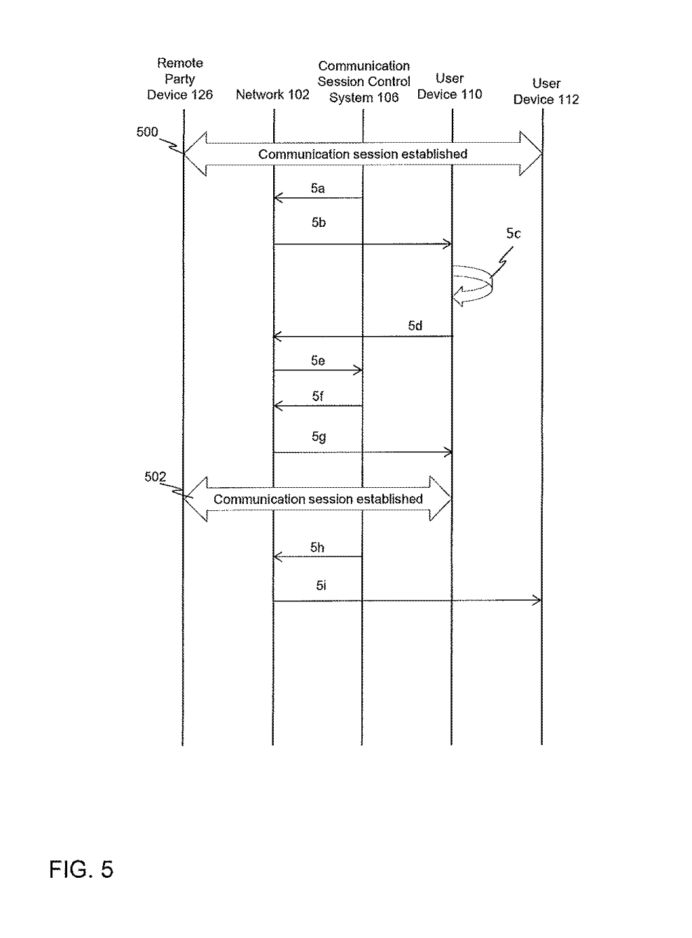

Embodiments described below in relation to FIG. 5 enable moving (or ‘jumping’ or ‘switching’) of an established communication session in telecommunications network 102. A communication session 300 is established between one of a plurality of user devices associated with a user at which the user can be contacted at, in this example user device 112, and a remote device 126 associated with a remote party. Mechanisms for establishing such a communication session are known to one skilled in the art and will not be described herein.

Communication session control system 106 is located in the signalling path for the established communication session and maintains a user database 180 containing user entries for a plurality of users, each user entry comprising contact data and/or a set of identifiers for user devices associated with the respective user.

Upon establishment of communication session 300 between user device 112 and remote party device 126, communication session control system 106 performs a lookup in database 180 for the user of user device 112 and determines that the user also has an associated user device 110. Communication session control system 106 therefore notifies user device 110, via network 102 in steps 5a and 5b, that there is a further user device 112 associated with the user and that further user device 112 is currently being used to conduct a communication session with a remote user device (in this case remote user device 126).

Upon receipt of the notification of step 5b, user interface 206 on user device 110 is configured to display at least one communication session move option to the user, in this case an option to move the communication session established between user device 112 and remote user device 126 to user device 110.

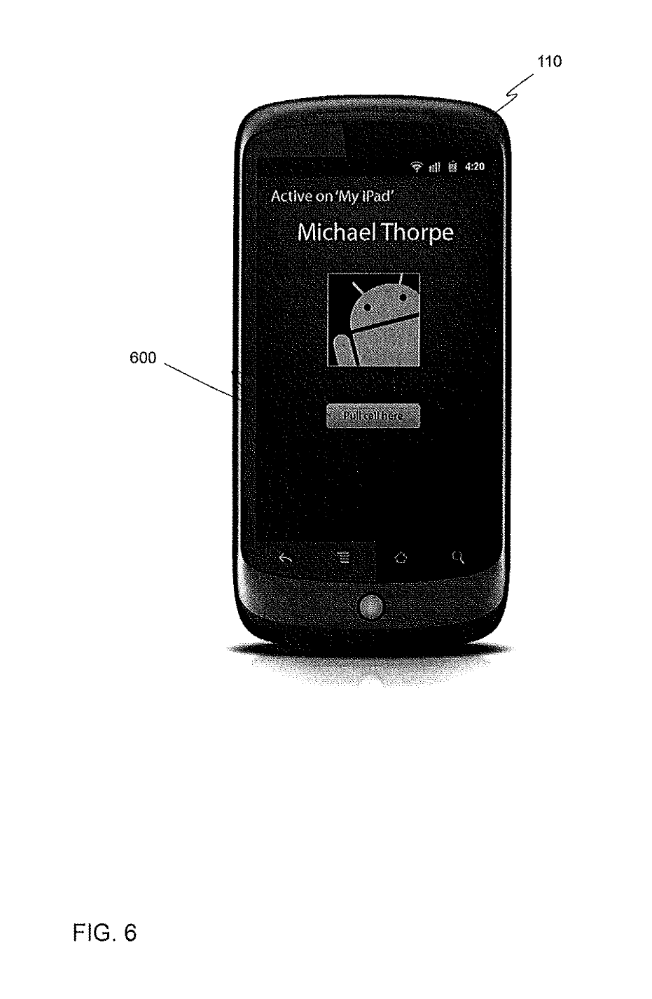

An example screen-shot of display of such a communication session move option to the user of user device 110 is given in FIG. 6. Here the user is informed that there is an active call with a third party (in this example somebody called ‘Michael Thorpe’) on user device 112 (which is an iPad™ in this example) and a ‘pull call here’ button 600 is displayed to the user on a touch-screen user interface of user device 110.

User input is received via user interface 206, as shown by step 5c, which indicates selection of the displayed at least one communication session jump option by the user of user device 110.

User device 110 transmits, to communication session control system 106, a communication session move request via network 102, as shown by steps 5d and 5e in FIG. 5. The communication session jump request of step 5e is operable to instruct communication session control system 106 to initiate moving of the established communication session from user device 112 to user device 110. In response to receipt of the communication session jump request of step 5e, communication session control system 106 initiates, in steps 5f and 5g, moving of the communication session established from user device 112 to user device 110.

In embodiments, the communication session move is conducted on the basis of a preconfigured data set, specific to the user, which identifies one or more of the plurality of user devices associated with the user. In some embodiments, the preconfigured data set is retrieved from database 180 by communication session control system 106. In other embodiments, the preconfigured data set is maintained by user device 112 and/or user device 110 and provided to communication session control system 106 by user device 112 and/or user device 110.

A communication session 502 is thus established between user device 110 and remote party device 126. The communication session 500 established between user device 112 and remote party device 126 is torn down in steps 5h and 5i such that communication session 502 replaces communication session 500.

The operation of moving a communication session from user device 112 to user device 110 as depicted in FIG. 5 can be described as a ‘pull’ operation from user device 112 to user device 110.

Embodiments can be applied to a scenario where a user with multiple associated user devices is initiating communication session move functionality on one of their user devices and has multiple options as to which other user device the communication session should be jumped to. The user is presented with a list of multiple available user devices to which the communication session could be moved to. In embodiments, when presenting a list of user devices to initiate the call move feature with, user devices are prioritised using configuration of the user interface on the current user device, for example through ordering or highlighting or suchlike. The prioritisation could for example be carried out such that devices which are known to be close to the user device currently being used to conduct a communication session are prioritised over other user devices. Since the user is more likely to want to move a current communication session to a user device which is close to the geographical location where they are currently, embodiments therefore help to reduce the time it takes for the user to identify the user device to which they wish to move the current communication session to.

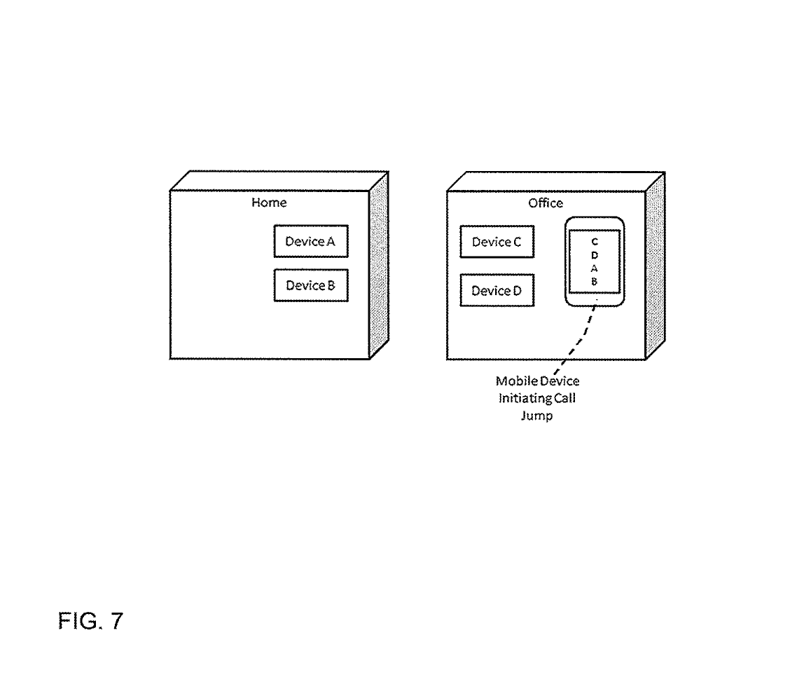

As an example embodiment, consider the situation where a user has a home landline (Device A) and a tablet computer with soft phone (Device B) at home, a desk phone (Device C) and a PC with soft phone (Device D) at work, and a mobile phone, all connected to the same number. The user is taking a call at work on their mobile phone as they arrive at work. When the user reaches their desk, the user activates the “Call Jump” feature on their mobile phone. According to embodiments, as the desk phone and work PC soft phone are known to be in the same location as the mobile phone, these items appear with priority over the home landline and tablet computer. A situation where a mobile device prioritises devices located in the office, when initiating moving of a communication session in the office is depicted in FIG. 7 where a list of user devices is displayed on a user's mobile phone with user devices C and D being prioritised over user devices A and B (due to the fact that user devices C and D are above user devices A and B in the list of communication session move options displayed to the user on the mobile phone).

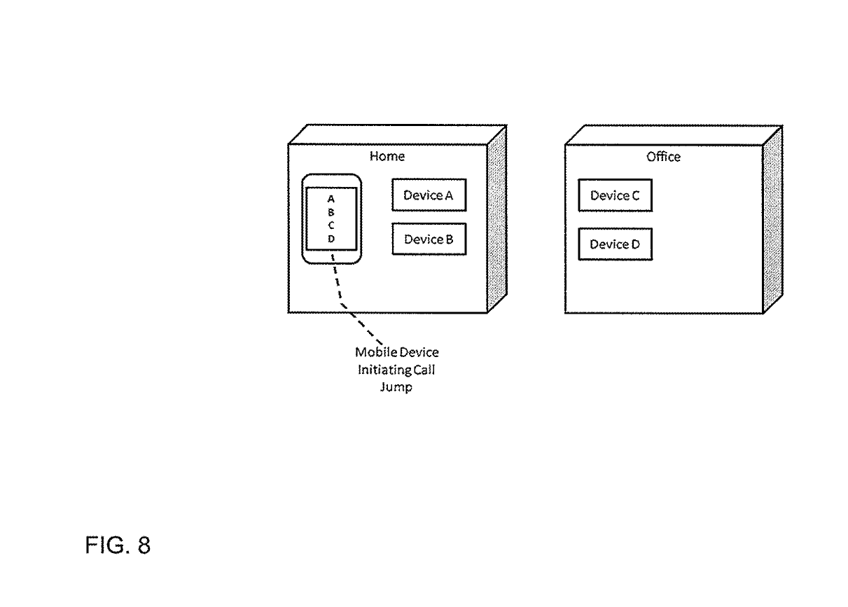

As another example embodiment, when the user is at home, the home landline and tablet computer are prioritised for moving of a communication session from the mobile phone. Such a situation where a mobile device prioritises devices located at home, when initiating moving of a communication session at home is depicted in FIG. 8 where a list of user devices is displayed on a user's mobile phone with user devices A and B being prioritised over user devices C and D according to embodiments (due to the fact that user devices A and B are above user devices C and D in the list of communication session move options displayed to the user on the mobile phone).

In embodiments, if there are no user devices nearby, then all user devices are displayed in a way that indicates that they are not nearby.

As another example embodiment, if a user is travelling on business and location data from the mobile phone indicates that the user is not in any of the normal locations recorded in the database, when the mobile phone is initiating moving of a communication session, devices that are known to be commonly co-located with it (for example a work laptop or a tablet PC) are prioritised over other user devices.

Embodiments comprise measures, including methods, apparatus and computer software for use in moving an established communication session in a telecommunications network, the communication session being established between a first device in a plurality of user devices associated with a user and a remote device associated with a remote party, to a second device in the plurality, the method comprising, at a given device in the plurality:

on the basis of prioritisation data indicating a prioritisation of at least one user device in the plurality over at least one other user device in the plurality for moving the established communication session to, configuring a user interface on the given device to display at least one communication session move option to the user;

receiving, via the user interface, user input indicating selection of the displayed at least one communication session move option by the user; and

initiating move of the established communication from the first device in the plurality to the second device in the plurality.

In some embodiments the prioritisation data is determined at the given device. In other embodiments data the prioritisation data is determined by a communication session control system located in the signalling path for the established communication session and is transmitted from the communication session control system and received at the given device.

In embodiments, the configuring comprises configuring the user interface to display one or more communication session move options associated with the at least one user device in the plurality differently from one or more other communication session move options associated with the least one other user device in the plurality.

In embodiments, configuring the user interface to display the one or more communication session move options differently from the one or more other communication session move options comprises configuring the user interface to order the one or more communication session move options above the one or more other communication session move options in a list displayed on the user interface.

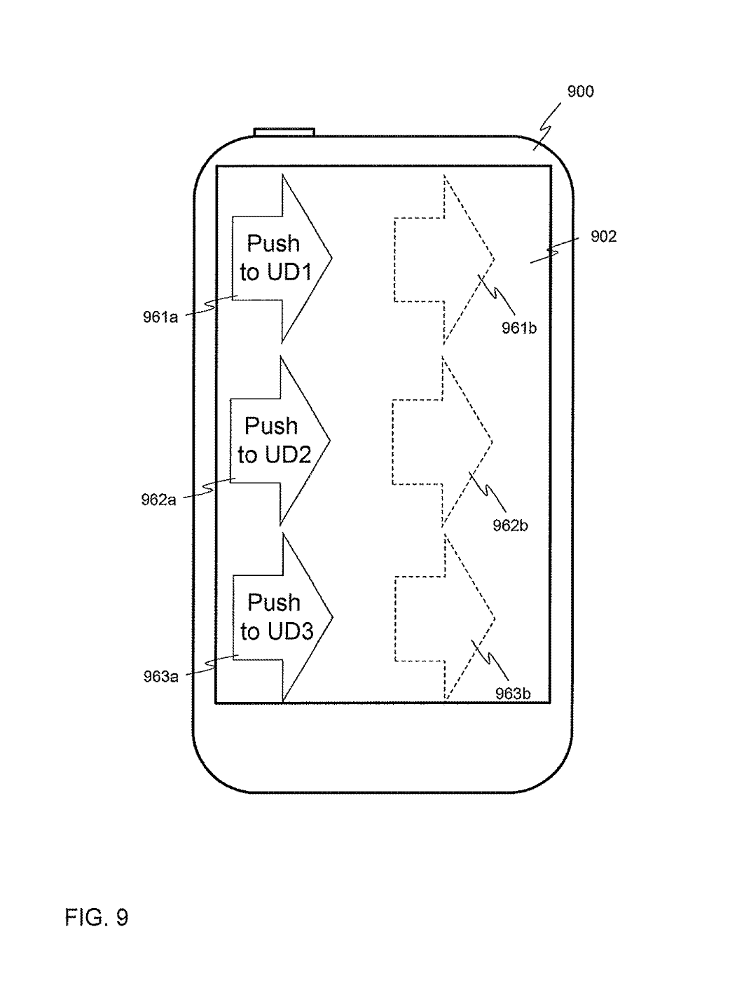

FIG. 9 is a front view of a user device 900 according to embodiments. User device 900 comprises a touch-screen user interface 902 which has been configured to display the communication session move option associated with button 961a above the communication session move option associated with button 962a which is in turn displayed above the communication session move option associated with button 963a on touch-screen user interface 902. In these embodiments, the order of prioritisation of the communication session move options is button 961a with the highest priority, followed by button 962a with an intermediate priority, followed by button 963a with the lowest priority.

In these embodiments, button 961a includes the text ‘Push to UD1’ indicating to the user that selecting this button will allow them to push the established communication session to a user device 1. The arrow form of the button which points to the right, indicates to the user that they should touch the button located in position 961a and slide the button to the right to position 961b in order to initiate moving of the communication session to user device 1.

In these embodiments, button 962a includes the text ‘Push to UD2’ indicating to the user that selecting this button will allow them to push the established communication session to a user device 2. The arrow form of the button which points to the right, indicates to the user that they should touch the button located in position 962a and slide the button to the right to position 962b in order to initiate moving of the communication session to user device 2.

In these embodiments, button 963a includes the text ‘Push to UD3’ indicating to the user that selecting this button will allow them to push the established communication session to a user device 3. The arrow form of the button which points to the right, indicates to the user that they should touch the button located in position 963a and slide the button to the right to position 963b in order to initiate moving of the communication session to user device 3.

Whilst the embodiments of FIG. 9 have been described in relation to a push operation, such embodiments could be applied to a pull operation.

In embodiments, configuring the user interface to display the one or more communication session move options differently from the one or more other communication session move options comprises configuring the user interface to highlight and/or shade and/or colour the one or more communication session move options and not highlight and/or shade and/or colour the one or more other communication session move options on the user interface.

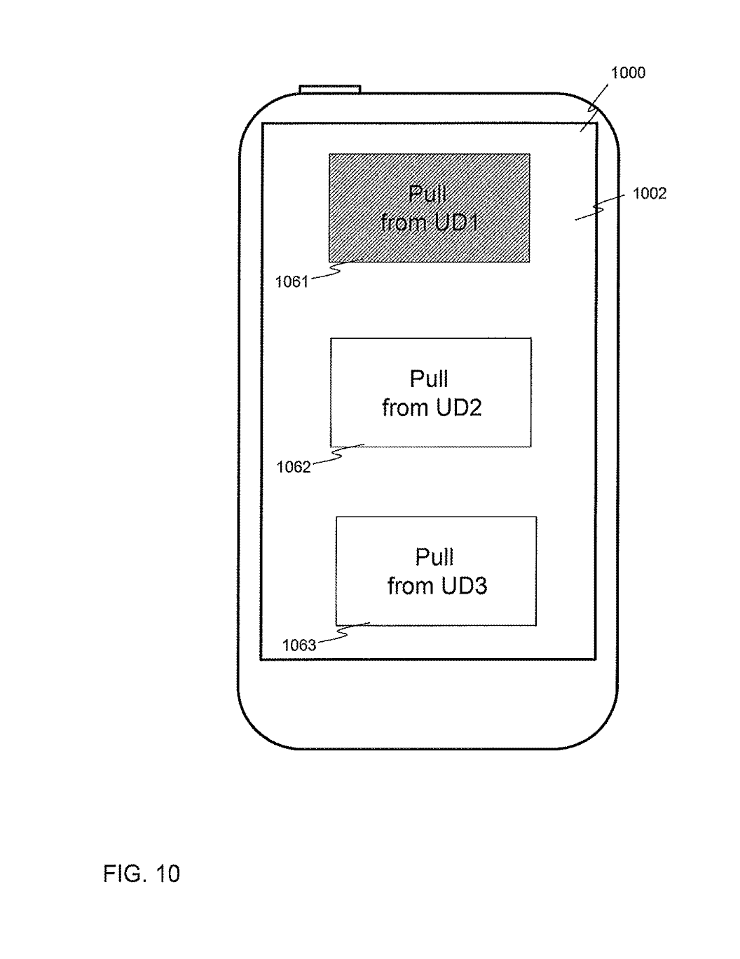

FIG. 10 is a front view of a user device 1000 according to embodiments. User device 1000 comprises a touch-screen user interface 1002 which has been configured to display the communication session move option associated with button 1061 in a highlighted/shaded form, whereas the communication session move options associated with buttons 1062 and 1063 are not in a highlighted/shaded form. In these embodiments, the order of prioritisation of the communication session move options is button 1061 with the highest priority, with buttons 1062 and 1063 having a lower priority.

In embodiments, configuring the user interface to display the one or more communication session move options differently from the one or more other communication session move options comprises configuring the user interface to display one or more touch sensitive buttons on a touch-sensitive portion of the user interface for the one or more communication session move options. In embodiments, configuring the user interface to display the one or more communication session move options differently from the one or more other communication session move options comprises not configuring the user interface to display any touch sensitive buttons on the touch-sensitive portion of the user interface for the one or more other communication session move options.

Whilst the embodiments of FIG. 10 have been described in relation to a pull operation, such embodiments could be applied to a push operation.

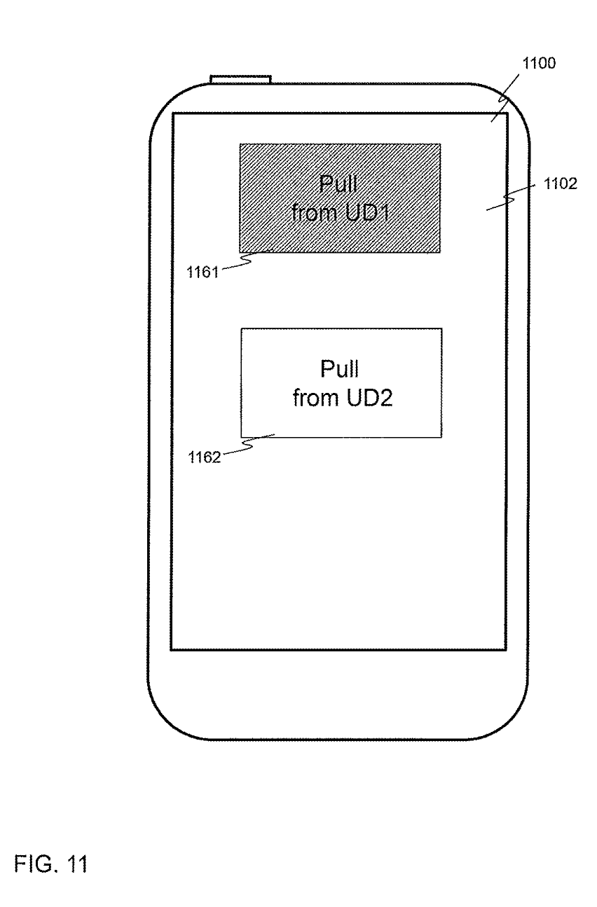

FIG. 11 is a front view of a user device 1100 according to embodiments. User device 1000 comprises a touch-screen user interface 1102 which has been configured to display the communication session move option associated with button 1161 in a highlighted/shaded form, whereas the communication session move option associated with button 1162 is not in a highlighted/shaded form. In these embodiments, even though a further communication session move option exists (for example associated with a pull operation from user device 3 say), no button associated with this option is configured on touch-screen user interface 1102. In these embodiments, the order of prioritisation of the communication session move options is button 1161 with the highest priority, followed by button 1162.

Whilst the embodiments of FIG. 11 have been described in relation to a pull operation, such embodiments could be applied to a push operation.

In embodiments, determination of the prioritisation data is carried out at least on the basis of geographical location data associated with one or more of the user devices in the plurality. The geographical location data may indicate that at least one of the one or more user devices in the plurality is a fixed-location user device; in such embodiments, the geographical location data may indicate a geographical location for the fixed-location user device. For example, the fixed-location user device may be a user device associated with one or more of a residence location for the user and a work location for the user. For example the geographical location data may indicate that user device 110 is a home landline phone whose location does not change, i.e. a fixed-location user device.

In embodiments, the fixed-location user device is a user device associated with one or more of a residence location for the user and a work location for the user. In the case of the fixed-location user device being a home landline phone, the geographical location data could for example indicate a latitude and longitude for the geographical location where the home is located. In the case of the fixed-location user device being a work deskphone, the geographical location data could for example indicate a latitude and longitude for the geographical location where the office is located.

In embodiments, the geographical location data indicates that at least one of the one or more user devices in the plurality comprises a mobile user device; in such embodiments, the geographical location data indicates a current geographical location for the mobile user device.

In embodiments, at least one of the one or more of the user devices in the plurality comprises a geographical location aware mobile user device. In such embodiments, at least a first part of the geographical location data is received from the geographical location aware mobile user device, the at least first part of the geographical location data having been determined by the geographical location aware mobile user device.

A geographical location aware mobile user device is a user device which is able to determine its own geographical location, for example via a global positioning system (GPS) module or other location determination functionality comprised within a smartphone user device. In such embodiments, the geographical location aware mobile user device determines its geographical location and transmits data associated with such to the given device and/or communication session control system 106. In embodiments, user device 112 is a mobile user device which is a geographical location aware mobile user device.

Embodiments comprise receiving at least a second part of the geographical location data from a communication session control system located in the signalling path for the established communication session, the second part of the geographical location data having been retrieved from a stored profile for the user by the communication session control system.

Embodiments comprise receiving at least a third part of the geographical location data from a geolocation network entity responsible for providing geographical location data for user devices in the network, the at least third part of the geographical location data having been determined by the geographical location network entity in relation to at least one of the one or more user devices in the plurality. The geolocation entity (depicted as entity 186 in FIG. 1) could for example determine a geographical location for a mobile user device 112 based on information obtained from basestations (not shown) in a mobile telephone network to triangulate an approximate position of the user device and provide this information to the given user device and/or communication session control system 106.

In embodiments, the geographical location data indicates that the given and the second user devices are currently located proximate to each other and the prioritisation data indicates that the second user device should be prioritised over one or more other user devices in the plurality for moving the established communication session to. Hence, if two user devices are currently proximate (i.e. relatively close) to each other (or ‘co-located’), for example a mobile phone user device and a fixed-location home landline when the user is carrying the mobile phone in the home, then the fixed-location home landline can be prioritised over other user devices associated with the user for communication session move purposes. Similarly, if two user devices are currently proximate to each other, for example a mobile phone user device and car telephone user device (i.e. both mobile user devices), then the car telephone user device can be prioritised over other user devices associated with the user for communication session move purposes. Proximate here could for example mean within 5 m of each other in the case of a home location, or for example mean within 50 m of each other in the case of an office location.

In embodiments, the geographical location data indicates that the given and the second user devices are not currently located proximate to each other and the prioritisation data indicates that one or more other user devices in the plurality should be prioritised over the second user device for moving the established communication session to. Hence, if two user devices are not currently close to each other, for example a mobile phone 112 and an office deskphone 116, then user devices associated with the user other than the office deskphone can be prioritised over the office deskphone for communication session move purposes.

In embodiments, the geographical location data indicates that at least one of the given and the second user devices is currently located at a predetermined location and the prioritisation data indicates that the second user device should be prioritised over one or more other user devices in the plurality for moving the established communication session to.

In embodiments, the geographical location data indicates that at least one of the given and second user devices is currently located at a predetermined location and the prioritisation data indicates that one or more other user devices in the plurality should be prioritised over the second user device for moving the established communication session to. For example, the geographical location data may indicate that a mobile user device 112 is currently located in a home location such that the home landline can be prioritised over other user devices associated with the user for communication session move purposes

In embodiments, the one or more other user devices comprises a fixed-location user device and the given user device comprises a mobile user device, wherein the predetermined location comprises a fixed location of the fixed-location user device.

In embodiments, the geographical location data indicates that both of the given and second user devices are located at the predetermined location.

In embodiments, determination of the prioritisation data is carried out further on the basis of one or more settings configured by the user. The user may configure settings in a user profile such that prioritisation of one of more of their user devices will depend at least on part on the configured settings. For example, a user may configure the system such that their work landline will be prioritised over their home landline for communication session move purposes during office hours, but that their home landline will be prioritised over their work landline for communication session move purposes during the weekend. Such configuration could for example be carried out via a web-interface (not shown) of communication session control system 106.

In some embodiments, the given user device comprises the first user device and the displayed at least one communication session move option comprises an option to push the communication session established on the first user device to the second user device. In other embodiments, the given user device comprises the second user device and the at least one communication session move option comprises an option to pull the communication session established on the first user device to the second user device.

In embodiments, the initiating comprises transmitting a communication session move request to a communication session control system located in the signalling path for the established communication session, the transmitted communication session move request being operable to instruct the communication session control system to initiate move of the established communication session from the first user device to the second user device.

In embodiments, determining the prioritisation data may comprise determining an order of priority/likelihood of which user devices may be useful to the user in a particular location for communication session move purposes. The following levels of confidence may for example be user to create a ranking of user devices for prioritisation purposes, with entries towards the top of the list having the highest confidence and entries towards the bottom of the list having the lowest confidence:
Location aware user device that is currently in this location.
Manually configured user device in this location.
Directly recorded in this location (including during an action involving a location aware or manually configured fixed location user device).
Manually configured as commonly co-located with a user device already involved in the action or known to be in this location.
Tentatively recorded in this location by association with a user device where this is the only location known
Tentatively recorded as commonly co-located with a device already involved in the action or known to be in this location.
Devices with no association with this location or devices already involved in the action.

In embodiments, a user manually configures one or more of the following in memory 204 and/or database 180 which can be used in the prioritisation process:
A location in the database, giving it a name. For example, taking the location recorded by the user device and storing it in the database with the name “office”.
the location, or locations associated with a particular device. For example, associating a laptop on which an instance of a session initiation protocol (SIP) client is running with the locations “office” and “home”.
whether a device is in a fixed location, or is mobile.
an association between two devices. For example, that a location aware mobile telephone is normally co-located with a non-location aware device, such as a laptop computer or a tablet computer.

In embodiments, determination of the prioritisation data is carried out further on the basis of historical location and/or communication session activity of at least one user device in the plurality. Data relating to such historical location and/or communication session activity may for example be stored in memory 204 of user device 200 and/or in database 180 and accessed/retrieved as and when a prioritisation process is carried out.

In embodiments, one or more of the following may be configured in memory 204 and/or database 180 by an automated or semi-automated process which builds up geographical location data over a period of time, for example controlled by software running on user device 200 and/or communication session control system 106:
location aware user devices will keep a record of their location when used to perform an action and this is added to the memory/database as one of their locations.
when an action is performed that indicates that a location aware user device is co-located with another device (for example, transferring a call between a mobile telephone and a landline), the location recorded will also be stored against the non-aware device.
when an action is performed between a non-location-aware device that is known to be in a fixed location and another non-location-aware device, the location of the fixed device will be stored against the non-location-aware device. A tentative location will be stored where a device has only one known location but has not been specified by the user to be in a fixed location.
a list of tentative associations between devices can be built up which keeps track of the number of successful co-located actions between user devices.

To maintain the quality of the memory/database, if an action is taken that indicates that a user device marked in the database as in a fixed location (or with only one known location in which it has been used many times) is not in the location retrieved from the memory/database, the user can be asked if they want to make the new location of the device as a replacement fixed location for the device, or whether to configure the device as mobile and store both locations against it.

The above embodiments are to be understood as illustrative examples. Further embodiments are envisaged.

Embodiments described above involve a part of the geographical location data being received from a user device and another part of the geographical location data being retrieved from a database. Embodiments also apply to any other combinations of such including receiving a part of the geographical location data from a geolocation network entity, or all the geographical location data being received from a user device or all the geographical location data being retrieved from a database or all the geographical location data from one or more geolocation network entities. In alternative embodiments, to avoid storage and retrieval of geographical location data from a database, some or all of geographical location data can be stored in local memory (not shown) within the given user device and/or communication session control system.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

1. A method for use in moving an established communication session in a telecommunications network, the communication session being established between a first device in a plurality of user devices associated with a user and a remote device associated with a remote party, to a second device in the plurality, the method comprising, at a given device in the plurality:
on the basis of prioritisation data indicating a prioritisation of at least one user device in the plurality over at least one other user device in the plurality for moving the established communication session to, configuring a user interface on the given device to display at least one communication session move option to the user;
receiving, via the user interface, user input indicating selection of the displayed at least one communication session move option by the user; and
initiating move of the established communication from the first device in the plurality to the second device in the plurality.

2. The method according to claim 1, comprising determining the prioritisation data at the given device.

3. The method according to claim 1, comprising receiving the prioritisation data at the given device, the prioritisation data having been determined by a communication session control system located in the signalling path for the established communication session.

4. The method according to claim 1, wherein the configuring comprises configuring the user interface to display one or more communication session move options associated with the at least one user device in the plurality differently from one or more other communication session move options associated with the least one other user device in the plurality.

5. The method according to claim 4, wherein configuring the user interface to display the one or more communication session move options differently from the one or more other communication session move options comprises one or more of:
configuring the user interface to order the one or more communication session move options above the one or more other communication session move options in a list displayed on the user interface,
configuring the user interface to highlight and/or shade and/or colour the one or more communication session move options and not highlight and/or shade and/or colour the one or more other communication session move options on the user interface, and
configuring the user interface to display one or more touch sensitive buttons on a touch-sensitive portion of the user interface for the one or more communication session move options.

6. The method according to claim 5, wherein configuring the user interface to display the one or more communication session move options differently from the one or more other communication session move options comprises not configuring the user interface to display any touch sensitive buttons on the touch-sensitive portion of the user interface for the one or more other communication session move options.

7. The method according to claim 2, wherein determination of the prioritisation data is carried out at least on the basis of geographical location data associated with one or more of the user devices in the plurality.

8. The method according to claim 7, wherein the geographical location data indicates that at least one of the one or more user devices in the plurality is a fixed-location user device.

9. The method according to claim 8, wherein the geographical location data indicates a geographical location for the fixed-location user device.

10. The method according to claim 8, wherein the fixed-location user device is a user device associated with one or more of a residence location for the user and a work location for the user.

11. The method according to claim 7, wherein the geographical location data indicates that at least one of the one or more user devices in the plurality comprises a mobile user device.

12. The method according to claim 11, wherein the geographical location data indicates a current geographical location for the mobile user device.

13. The method according to claim 7, wherein at least one of the one or more of the user devices in the plurality comprises a geographical location aware mobile user device,
the method comprising receiving at least a first part of the geographical location data from the geographical location aware mobile user device, the at least first part of the geographical location data having been determined by the geographical location aware mobile user device.

14. The method according to claim 7, comprising:
receiving at least a second part of the geographical location data from a communication session control system located in the signalling path for the established communication session, the second part of the geographical location data having been retrieved from a stored profile for the user by the communication session control system, and/or
receiving at least a third part of the geographical location data from a geolocation network entity responsible for providing geographical location data for user devices in the network, the at least third part of the geographical location data having been determined by the geographical location network entity in relation to at least one of the one or more user devices in the plurality.

15. The method according to claim 7, wherein the geographical location data indicates one or more of:
that the given and the second user devices are currently located proximate to each other and the prioritisation data indicates that the second user device should be prioritised over one or more other user devices in the plurality for moving the established communication session to.
that the given and the second user devices are not currently located proximate to each other and the prioritisation data indicates that one or more other user devices in the plurality should be prioritised over the second user device for moving the established communication session to,
that at least one of the given and the second user devices is currently located at a predetermined location and the prioritisation data indicates that the second user device should be prioritised over one or more other user devices in the plurality for moving the established communication session to, and
that at least one of the given and second user devices is currently located at a predetermined location and the prioritisation data indicates that one or more other user devices in the plurality should be prioritised over the second user device for moving the established communication session to.

16. The method according to claim 15, wherein the one or more other user devices comprise a fixed-location user device and the given user device comprises a mobile user device, wherein the predetermined location comprises a fixed location of the fixed-location user device.

17. The method according to claim 15, wherein the geographical location data indicates that both of the given and second user devices are located at the predetermined location.

18. The method according to claim 2, wherein determination of the prioritisation data is carried out further on the basis of:
historical location and/or communication session activity of at least one user device in the plurality, and/or
one or more settings configured by the user.

19. The method according to claim 1, wherein:
the given user device comprises the first user device and the displayed at least one communication session move option comprises an option to push the communication session established on the first user device to the second user device, or
the given user device comprises the second user device and the at least one communication session move option comprises an option to pull the communication session established on the first user device to the second user device.

20. The method according to claim 1, wherein the initiating comprises transmitting a communication session move request to a communication session control system located in the signalling path for the established communication session, the transmitted communication session move request being operable to instruct the communication session control system to initiate move of the established communication session from the first user device to the second user device.

21. Apparatus for use in moving an established communication session in a telecommunications network, the communication session being established between a first device in a plurality of user devices associated with a user and a remote device associated with a remote party, to a second device in the plurality, the apparatus comprising at least one processor, and at least one memory including computer program code, the at least one memory and the computer program code being configured to, with the at least one processor, cause the apparatus at least to, at a given device in the plurality:
on the basis of prioritisation data indicating a prioritisation of at least one user device in the plurality over at least one other user device in the plurality for moving the established communication session to, configure a user interface on the given device to display at least one communication session move option to the user;
receive, via the user interface, user input indicating selection of the displayed at least one communication session move option by the user; and
initiate move of the established communication from the first device in the plurality to the second device in the plurality.

22. A computer program product comprising a non-transitory computer-readable storage medium having computer readable instructions stored thereon, the computer readable instructions being executable by a computerised device to cause the computerised device to perform a method for use in moving an established communication session in a telecommunications network, the communication session being established between a first device in a plurality of user devices associated with a user and a remote device associated with a remote party, to a second device in the plurality, the method comprising, at a given device in the plurality:
on the basis of prioritisation data indicating a prioritisation of at least one user device in the plurality over at least one other user device in the plurality for moving the established communication session to, configuring a user interface on the given device to display at least one communication session move option to the user;
receiving, via the user interface, user input indicating selection of the displayed at least one communication session move option by the user; and
initiating move of the established communication from the first device in the plurality to the second device in the plurality.
